(19) United States
(12) Patent Application Publication
(10) Pub. No.: US 2019/0197521 A1
(43) Pub. Date: Jun. 27, 2019

(54) MERCHANT-CENTRIC GIFT CARD PROCESSING

(71) Applicants: Peter Rhee, San Mateo, CA (US); Edmar Soriano, Newark, CA (US); Alexander Campbell, Daly City, CA (US); Wesley Kimathi Marangu, Burlingame, CA (US)

(72) Inventors: Peter Rhee, San Mateo, CA (US); Edmar Soriano, Newark, CA (US); Alexander Campbell, Daly City, CA (US); Wesley Kimathi Marangu, Burlingame, CA (US)

(21) Appl. No.: 15/853,367

(22) Filed: Dec. 22, 2017

(51) Int. Cl. G06Q 20/34; G06Q 20/02; G06Q 20/20

(52) U.S. Cl. CPC G06Q 20/342; G06Q 20/204; G06Q 20/3433; G06Q 20/023

(57) ABSTRACT

A system of servers and algorithms allows merchants to receive value on behalf of a customer as a gift from a third party or for the merchant to proactively award value to the customer. The system receives an indication of credit sponsored by the merchant for a personal account number (PAN) of the customer. The system then creates a specialized monitor for the customer's transactions to identify transactions meeting certain criteria, including merchant, and applies the credited funds for the purchases. These credits may be made in real time at the register during a purchase or via a statement credit when the customer's bill is processed. The scope of the monitoring process may be expanded to partner brands or co-marketing partners. As the funds are applied, the system generates a settlement message to transfer funds from the merchant to an issuer associated with the PAN or other clearinghouse.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Gift cards and e-gift codes have become popular as an alternative to cash or other physical gifts. Some givers may feel that a gift card for a particular merchant may be more likely than cash to be used for something for the recipient. Other givers may know that a recipient likes that merchant and can use the gift card as a reason to visit there, whether a brick and mortar store or online. In some cases, a merchant may award gift cards to a customer for some past behavior, such as reaching a level of purchases with the merchant. However, recipients/customers may often lose or forget gift cards which can cause them to become frustrated. Gift cards may also raise escheatment issues when funds are held by third parties on behalf of a customer.

Further, gift cards and gift codes are subject to high fraud rates resulting from, among other methods, card bots sweeping through active card numbers, three-way call balance checks, package tampering, and card switching.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, a system of specially programmed servers and algorithms allows a merchant collect gift funds or award funds to a customer by submitting a specialized transaction that flags a customer's open loop financial card so that future purchases made at that merchant may draw down the stored credit amount as a statement credit or instant savings. In this way, the gift amount is automatically available to the customer whenever a future purchase is made at the designated merchant. Because the gift amount is actually processed and held by the merchant, escheatment complications may be reduced because no third parties hold the funds on behalf of the customer. As opposed to a prior art system, no gift card portal or third party processor is required because all processing follows a normal flow-of-business through the merchant's acquirer and the customer's card issuer. Because of this processing flow and the ability to generate credit transactions, discounted gift amounts can be processed, for example, a $100 gift can be purchased for $80, with the merchant subsidizing the added value.

Further, the system may allow real time acknowledgement of the use of the gift by generating information that can sent to the customer via a text message, email, social media message, or other communication.

### BRIEF DESCRIPTION OF THE DRAWINGS

FIG. 1 illustrates a block diagram of prior art system elements for providing a store credit

FIG. 2 is a block diagram illustrating a store credit system in accordance with the current disclosure;

FIG. 3 is a block diagram illustrating a customer service terminal in accordance with the current disclosure;

FIG. 4 is a block diagram illustrating a monitor in accordance with the current disclosure; and

FIG. 5 is a flowchart of a method of managing store credit in accordance with the current disclosure.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

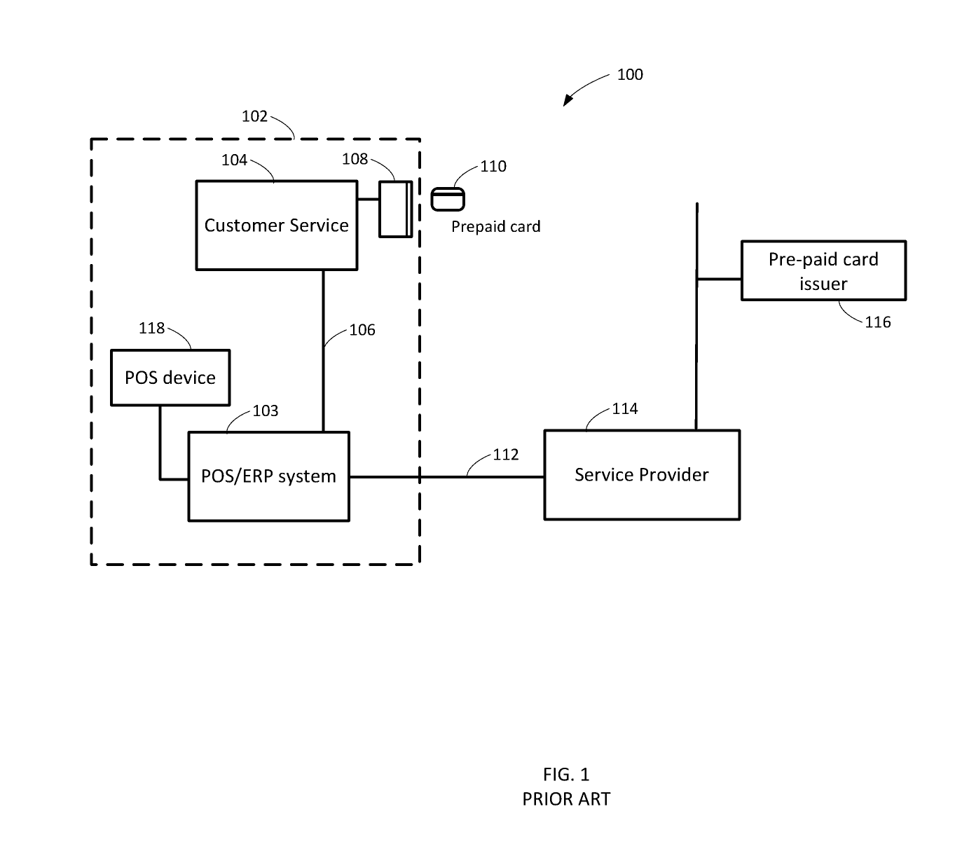

FIG. 1 is an illustration of a prior art system 100 that is used to provide a gift card to a customer using a merchant system 102. The merchant system 102 may include a point of sale (POS) system 103 coupled to a customer service terminal 104 by a network connection 106. The POS system 103 may include or be coupled to enterprise resource planning (ERP) functions such as inventory control, payroll, sales tracking, etc. In this illustration, the POS system 103 is be coupled to one or more POS devices 118 that are used to perform checkout functions for retail, in-person, sales. The customer service terminal 104 may be used to activate a gift card for use at the merchant, or in some cases for use at another merchant.

In this scenario, a swipe device 108 may be used to activate a prepaid card 110 (i.e. a closed loop card) via service provider 114 at a pre-paid card issuer 116. The service provider 114 may be an acquirer or a processor that receives transaction information, provides clearing and settlement services, or other transaction-related services. The prepaid card issuer 116 may receive the purchase price of the gift card from the merchant and hold the value of the prepaid card 110. When the user swipes the prepaid card, the prepaid card issuer 116 approves the transaction and delivers the funds back to the merchant during a settlement process. In the case where the prepaid card funds do not cover the cost of the transaction, the customer may have to provide a second card or cash to cover the remaining balance.

The merchant system 102 may be connected to the service provider 114 via a private network 112 or a virtual private network offering a high security connection for privacy and tamper-resistance. The same or a similar network 112 may connect the service provider 114 to the issuer 116.

Also as discussed above, the system 100 may require that the customer retain and remember to use the prepaid card 110 (or electronic gift code) when making a purchase with the merchant or an affiliate. The customer may be required to use the prepaid card 110 in a timely manner before any service fees are accumulated that may reduce or eliminate the value assigned to the card. Because the prepaid card 110 is anonymous, should the prepaid card 110 be lost or stolen, its associated value may also be lost, at least to the person to whom the card was issued, but perhaps not to a person who subsequently uses the prepaid card 110. This situation represents a double liability to the merchant—the original customer may be upset that the value was lost and in some regard blame the merchant, while the merchant or issuer 116 is still liable for the remaining value on the lost card.

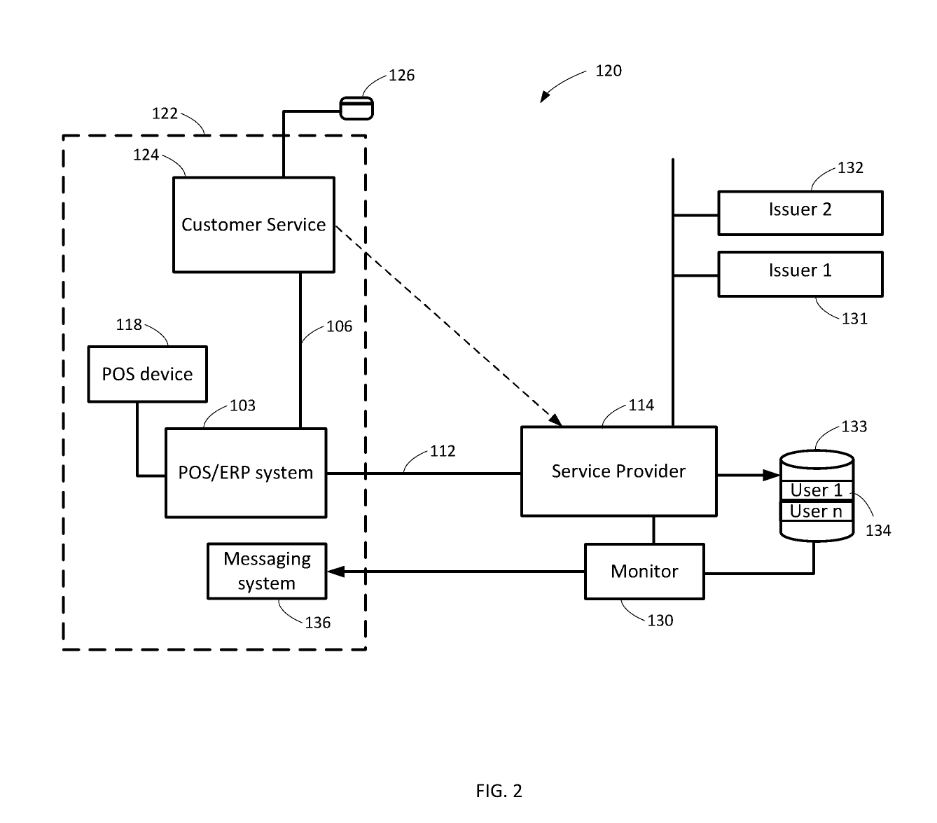

FIG. 2 is a block diagram that may represent a system 120 that provides a solution to the problems associated with using prepaid cards 110. Additional elements of the system 120 described below may provide for both the merchant-specific use of gift card value and an automatic application of funds whenever the user performs a transaction with the merchant or an authorized affiliate. Further, the system 120 may increase protection of merchants from fraudulent card use and protects customers from the risk of lost or stolen prepaid cards because the merchant actually retains the funds, i.e. credit, associated with the transaction and because the funds are associated with a customer's PAN. For example, a person attempting to gain funds through a fraudulent means may not want his or her primary open loop card associated with the fraud because discovery of the fraud would lead directly to the offender. Further, the same person might not want to risk associating the store credit with a stolen card because the card might be canceled at any moment.

The system 120 may include a merchant system 122 that is explained further below. The system 120 may also include the service provider 114 which may be an acquirer or a processor that receives transaction information, provides clearing and settlement services, or other transaction-related services with the same and/or expanded functionality as that discussed above.

A monitor 130 may screen transactions being processed by the service provider 114. The monitor 130 may be coupled to a database 133 that may store credit value information 134 for one or more users as well as data related to conditions for using the stored value. In various embodiments, the monitor 130, database 133, or both may be part of the service provider's domain. In other embodiments, these elements may be independently operated. One or more issuers 131, 132 may issue, among other financial instruments, open loop cards for credit and debit services as are normally provided to its card holders. In the described embodiment, the issuers 131, 132 may not be a party to the application of store credit to a transaction other than the ultimate settlement.

Logically, the monitor 130 may be a computing device such as a server that is designed and built to monitor the transactions being processed. The monitor 130 server may have a high throughput design such that transactions will not be delayed. Further, users looking to use the credit value may not desire to wait so speed in processing and communication may be of increased importance in the monitor 130 server. In some embodiments, the monitor 130 may be on a dedicated monitor server and in other embodiments, the monitor 130 may be a dedicated processor inside one of more servers which may be geographically local or dispersed in a cloud like computing system.

The merchant system 122 may include, as above, a POS device 118 and a POS system 103. In an embodiment, these two elements of the merchant system 122 may be the same the prior art system in order to increase backwards compatibility and reduce installation costs.

A customer service terminal 124 may be capable of providing prior art prepaid cards 110 but may also be modified as described more below to allow a customer to provide a physical card 126 or card personal account number (PAN) using a card swipe, tap, or, dip or manual entry of a PAN or other financial instrument identifier. The customer service terminal 124 may also include custom software and/or hardware that allows use of new transaction classes tailored to the generation of gift and/or credit value including both user interface elements and transaction processing elements. This process may create in essence a direct message to the service provider 114. This direct message may allow the service provider to create a ledger-type entry of the credit amount to be associated with cardholder PAN and the merchant, as well as rules for redemption.

The card 126 may be an existing card of the customer's, for example, an open-loop credit or debit card or similar financial instrument offered through one of the issuers 131, 132. The card may be a physical object such as a plastic card that resembles a traditional credit card or may be a virtual card or virtual account that is an electronic representation on a computing device that is capable of interfacing with the various networks in the system 120 such as a token stored in a virtual wallet which may operate through a mobile computing device such as a smart phone or other mobile wearable devices.

In operation, a merchant may offer a gift or store credit to a customer in the form of a gift from a purchaser or for another reason such as a returned item. The customer service terminal 124 may capture the amount of gift credit to be provided to the customer. In an embodiment, the process may involve use of a custom transaction code supported by the service provider 114. As opposed to a credit (return value) transaction, the gift credit transaction may simply make an accounting entry at the monitor 130 to trigger monitoring for qualifying transactions without triggering an actual settlement operation.

After the gift amount has been entered, the customer may indicate an open loop credit or debit card with which the gift may be associated. In one embodiment, the customer may be given a code or website that can be used by the recipient to enter the open loop card at a later time. For example, the code may be a one-time code that can be used to designate an open loop card of a recipient of the gift. Unlike a gift card code that could be swept or tampered, since the value is not in the code but with the open loop card with which the value is ultimately associated, tampering would have little worth for an attacker, for at least the reasons discussed above. In some embodiments, the point of sale device may be used to indicate the account for which the gift may be associated. In other embodiments, a portable computing device may be used to indicate the account for which the gift may be associated.

The merchant may further specify during the gift or award transaction the merchant, e.g., brand or brands, with which the gift value may be redeemed. In an embodiment, special programming of the customer service terminal 124 may allow different brands to be specified for a particular gift/credit amount. For example, a refund on a returned item may limited to the branded store where the item was purchased while a gift amount may be open to a family of associated brands.

The customer service terminal 124, in an embodiment, via the POS system 103, may then submit the credit transaction to the service provider 114. The service provider 114, or monitor 130, may accept the credit transaction and store the credit amount, the merchant (brand), PAN and any other restrictions or information, such as a cell phone number of the customer, in the database 133. It may be noted that actual funds may not be transferred at this time, only the data associated with the store credit. Only as subsequent transactions are qualified and the store credit is applied, for example, via a statement credit, are the funds transferred from the merchant during settlement.

In another embodiment, a gift amount may be purchased in an online transaction with a customer service function 124 that accepts another form of payment, such as a different open loop card, a stored value gift card, awards points, or existing merchant credit. In such an embodiment, a code as discussed above may be used to allow the eventual recipient to tie the value to an open loop card of the recipient's choice.

In another embodiment, the merchant may offer a discount on the price of the gift so that a customer may purchase a $50 face value gift value for $40, or some other discounted amount. Because the merchant performs the transaction from the receipt of the funds to the creation of the credit value message, the two are essentially independent of each other. Should the merchant decide to offer a discount to, for example, preferred customers, the merchant may use a marketing budget to offset the value. In a traditional prior art gift card environment, the pre-paid card issuer is responsible for the face value of the gift card and may have no motivation to offer a discounted card.

After this initial data entry, the monitor 130 may review authorization and settlement streams for a transaction that matches the terms of the gift/award. For example, the database can be searched for components of the transaction including the required merchant, the required PAN, and value in the customer's gift account 134. In some embodiments, the gift/award is indicated with an indication that may be part of the transaction. The indication may follow a protocol that may have been created in advance and communicated to the parties of the transaction. In this embodiment, the system may be efficient and reliable as all parties may understand what to expect in dedicated places in the transaction communication. Thus, the technical problem of how to quickly and accurately identify gift transactions may be addressed.

When a gift account is identified that matches these criteria, the monitor 130 may mark the transaction and post a credit to the customer's credit card with the matching PAN, while reducing the value in the gift amount by the amount of the purchase, up to the value in the account. In an embodiment, this credit may be made in real time during the processing of the transaction so that the credit is realized at the POS device 118 during the purchase. In another embodiment, the credit may be made in the form of a statement credit as part of the customer's normal credit card billing cycle.

The monitor 130 may also be connected to a messaging system 136. The messaging system as illustrated in FIG. 2 may be part of the merchant system 122 but in other embodiments the messaging system 136 may be operated by the service provider 114 or an outside service (not depicted). Logically, the messaging system may include one or more servers designed and built to communicate messages as part of the system. The servers may be geographically local or may be spread out geographically,

In an embodiment, data provided by or known about the customer or recipient may include contact information such as an email address, a mobile phone number, or social media information. In such a case, the monitor 130 may communicate a signal to the messaging system 136 which in turn may notify the recipient that a current or recent purchase will have the gift credit applied to the transaction. In this way, the merchant may be able to reinforce the brand message each time a gift credit is applied to a purchase or when the gift amount has been fully utilized.

The credit provider may be able to design a graphical interface that is unique as part of the credit providing process. A backend system may be available for the credit issuers of the system to design communications that may be used to indicate that credit is coming from a unique issuer. For example, a trademark may be included as part of the communication. In other embodiments, an advertising campaign may be included as part of the communication. For example, if the credit is related to a football related advertising campaign, the football advertising copy may be included as part of the communication. Of course, the communication may also include sounds, vibrations and other sensory notifications alone or in combination.

To utilize the gift or award credit, the customer may not be required to do anything other than use the open-loop card with which the credit was associated to make a purchase at the designated merchant or brand. Because no actual value may be transferred until settlement, the issuer 131 may not be aware of the application of the credit value to the purchase until the transaction is cleared prior to the customer statement being prepared. That is, the application of the credit may not involve pre-purchase transfer of value either from the merchant to the service provider 114 or the issuer 131, unlike prior art gift card credit solutions.

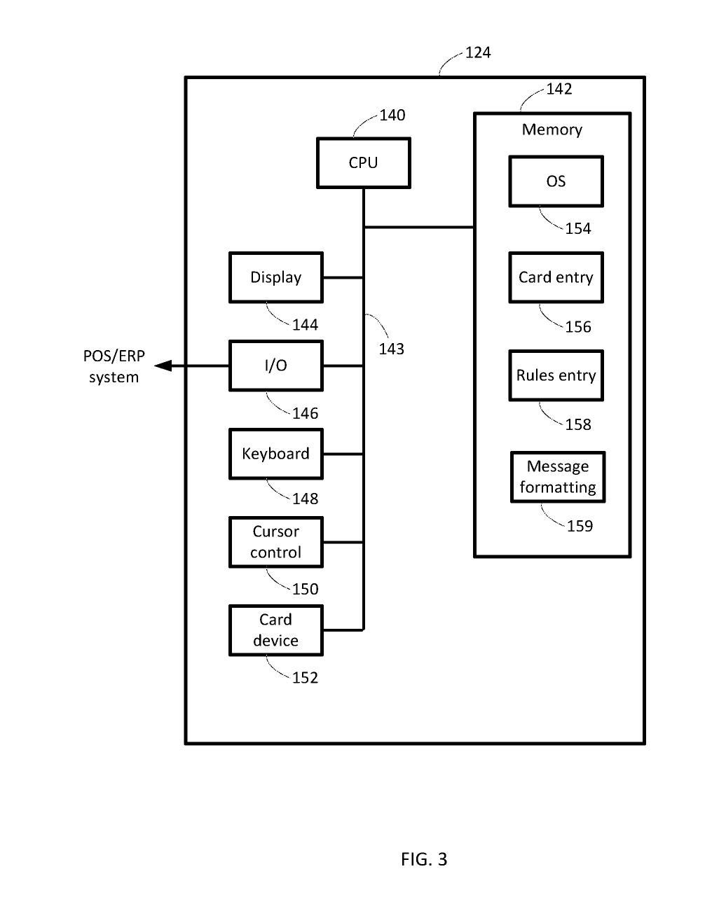

FIG. 3 is a block diagram of one embodiment of the customer service terminal 124 illustrating one embodiment suitable for use in the system 120. A central processing unit (CPU) 140 may execute instructions stored in a memory 142. The CPU 140 and memory, as well as other peripheral devices may be connected via a data bus 143. The customer service terminal 124 may have peripheral devices including a display 144, an input/output (I/O) unit 146, a keyboard or other user interface input element such as a cursor control device 150 such as a touchpad or mouse, and, in an embodiment, a card device 152. The display 144 may present data to a user such as a customer service person and/or a customer. The display 144 may include a touchscreen so that persons interacting with the customer service terminal 124 may be able to input data via the touchscreen or a different peripheral. In an embodiment, the display 144 may mounted on a swivel so that the display 144 may be rotated for viewing by and/or interaction with a customer.

The I/O unit 146 may be a network interface card or a section of a processor that supports communication between the terminal 124 and external systems, in particular the POS system 103. The I/O unit 146 may be or include a network interface card supporting IEEE 802.x communication protocols, such as 802.3 for wired Ethernet communication and 802.11 for wireless (WiFi) communication. The keyboard 148 may provide for manual data entry of text, for example, entry of customer data, capture of return information, or manual entry of PAN data for the customer's open loop card.

The cursor control device 150 may be a mouse or touchpad that allows the operator (customer service person or customer) to move a data entry point on the display 144. A card device 152 may allow a customer to dip, tap, or swipe his or her card in order to associate that card's PAN with the refund transaction.

The memory 142 may contain executable code in several categories. In one category may be code modules, such as an operating system 154, that provide generic functionality to the customer service terminal 124. The operating system 154 may support communication functions between internal and external peripheral and devices, may support memory management, and may support basic input/output functions such as the ability to display text and graphics and receive user input. Other code modules may support custom functions that differentiate the customer service terminal 142 from a generic computer. Such code modules may include a card entry module 156, a rules capture module 158, and message formatting 159.

The card entry module 156 may support interactions with the card device 152, for example, supporting collection of PAN and/or token information from a customer's open loop card 126. The card entry module 156 may accept more than simply a PAN, such as from reading a magnetic strip. For example, when the card 126 is a chip card, the card 126 may generate a cryptogram associated with the credit return function that card entry module 156 may capture for use by in an authorization message to the service provider 114 to create the credit entry.

As discussed more below, rules or algorithms may be used to define the environment for which the gift or credit may be used. These rules may include what merchant or store brands may be used for qualifying purchases, purchase limits, day-of-week or time-of-day limits, etc., The rules entry module 158 may be used to guide a customer service representative through entry of the refund and generation of corresponding rules, such as those just mentioned. Similarly, in an online environment, the rules may specify to a purchaser what limits may be placed on use of the value.

A message formatting module 159 may ensure that a credit message that will ultimately be processed by the service provider 114 has all required data and that the data is correctly formatted. For example, when using a tokenized PAN, a cryptogram may be required to be included in the message, where a PAN taken from a magnetic strip may not have a cryptogram. The message formatting module 159 may identify the specific type (or sub-type) of stored credit message and apply the appropriate syntax rules for constructing the appropriate message. As mentioned previously, a protocol and an application programming interface may be used to assist in ensure the credit data is in a known format such that it may be reviewed and processed in a known and efficient manner.

The customer service terminal 124 may provide an experience not found in a prior art terminal 104. The terminal 124 may support additional features and functions such as a new store credit transaction that may involve both entry of a PAN as well as entry of rules governing use of the stored credit. Further, the customer service terminal may have advanced display and sound capabilities that may be utilized to generate additional interest and provide additional information to a user.

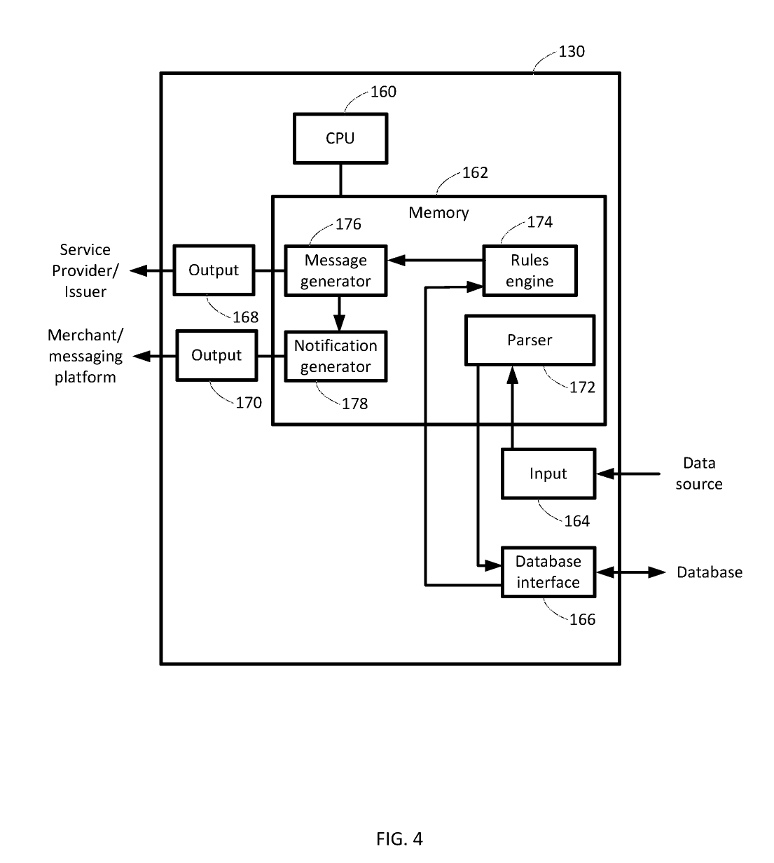

FIG. 4 is a block diagram of one embodiment of the monitor 130. As mentioned previously, the monitor 130 may be a dedicated device and may include a central processing unit (CPU) 160 that executes code stored in a memory 162. The monitor 130 may also include an input 164 coupled to a data source that provides transaction settlement and clearing messages. One such data source may be the service provider 114. The input 164 may include hardware and firmware that signal level interfaces, handshaking, message protocol, error management, etc. In an embodiment, the input may be an IEEE 802.x network interface card, such as those available from Intel Corporate or similar products.

In an embodiment, the parser 172 may receive a stream of settlement and clearing messages and process those messages into data elements including, but not limited to a transaction identifier, customer PAN, merchant identifier, and transaction value. This data extraction and formatting process may also involve excluding various transaction types that may not be relevant to the target transaction, such as ATM withdrawals, etc. Additional transactions may be screened at a high level. For example, the parser 172 may exclude transactions from countries where such a process may be prohibited.

The results from the parser 172 may be provided to a database interface 166 that may formulate queries to the database 133 and receive search results. The queries may simply look for a dataset that match a union of merchant ID, customer PAN, and a positive credit value. When a single match is found, the results may be passed to a rules engine 174. The database interface 166 may also handle both expected responses and error conditions, such as no match and multiple matches, respectively. In the latter case, some error resolution process may be entered or the transaction may be flagged for later follow up. For example, if more than one credit is available for use, the customer may be contacted regarding which account to use, or another rule may be applied, such as the oldest value is used first. Multiple credit values may be accumulated, for example, if gift value is purchased at more than one merchant but the merchants are linked by brand, multiple value entries may be available for a single purchase.

The rules engine may further qualify the transaction, for example, confirming that the transaction is within a prescribed date range. The rules engine 174 may also calculate any discount to the transaction, taking into account the effect of local taxes or other discounts already applied. The rules engine 174 may also calculate the reduction in stored credit for the PAN and generate the database transaction for use by the database interface 166 to make the update. In general, the full amount of stored credit may be applied to a transaction up to the amount of the purchase. If the transaction value is less than the full amount of stored credit, the amount of the transaction may be deducted from the stored value amount and the database updated with the remaining value. In some cases, special rules may be enforced such as the reduction is valid on a single purchase only so that if the transaction value is less than stored value amount, the remaining stored value may simply be discarded. Other rules may include day-of-the-week restrictions that, for example, a restaurant may impose.

A message generator 176 may receive transaction data from the rules engine 174 for use in generating transaction messages that actually cause the credit to be applied to the transaction, either as an instant discount or as a settlement amount. These messages may be queued and sent via an output 168 that manages the message protocol including confirmations and errors. The message generator 176 may also communicate with a notification generator 178 responsive to successful application of a credit to a transaction. The notification generator 178 may format one or more messages that ultimately are sent to the customer. The messages may include email, text messages, social media posts or combinations of these and others. The output 170 may manage communication protocols and other message-level tasks.

In an embodiment, for larger or more media-savvy companies, the message indicating a transaction has occurred may be sent to the messaging system 136 of the merchant platform 122 so that the merchant can manage the delivery and branding of the information about use of the stored value. A backend system may be provided with a user interface which may indicate to a merchant a variety of data at a glance such as the amount of credit redeemed, the credit campaign which is being used most often, the credit campaign outstanding, etc. The backend also may be used to design the details of a campaign, such as the rules used by the rules engine, the amount of the campaign, the look of the communication to customers, etc.

For other perhaps smaller or less sophisticated merchants in another embodiment, the notification generator 178 may directly communicate a stored credit activity message to the customer via one of more of the message channels. In such an embodiment, the notification generator 178 may publish an application programming interface (API) or allow other access that enables the merchant to manage the branding of the message without carrying the overhead of a separate messaging system 136.

The notification generator 178 may prepare customer notifications indicating when value is added to an open loop card as well as when value is applied to a transaction. In an embodiment, the customer may be able to communicate a message to the notification generator 178 which triggers a response with the remaining balance of the credit value associated with one or all merchants. For example, the customer may simply text “balance” to the notification generator 178 to receive the remaining value for all merchants with outstanding balances. In another embodiment, the customer may text or otherwise message either the merchant's messaging system 136 or communicate a text with “merchant_name” to the notification generator 178 to receive in response a balance for that specific merchant. Logically, the notification generator 178 may also operate according to a published API for efficient and reliable results. In an embodiment, a representational state transfer (REST) paradigm may be used for the interface.

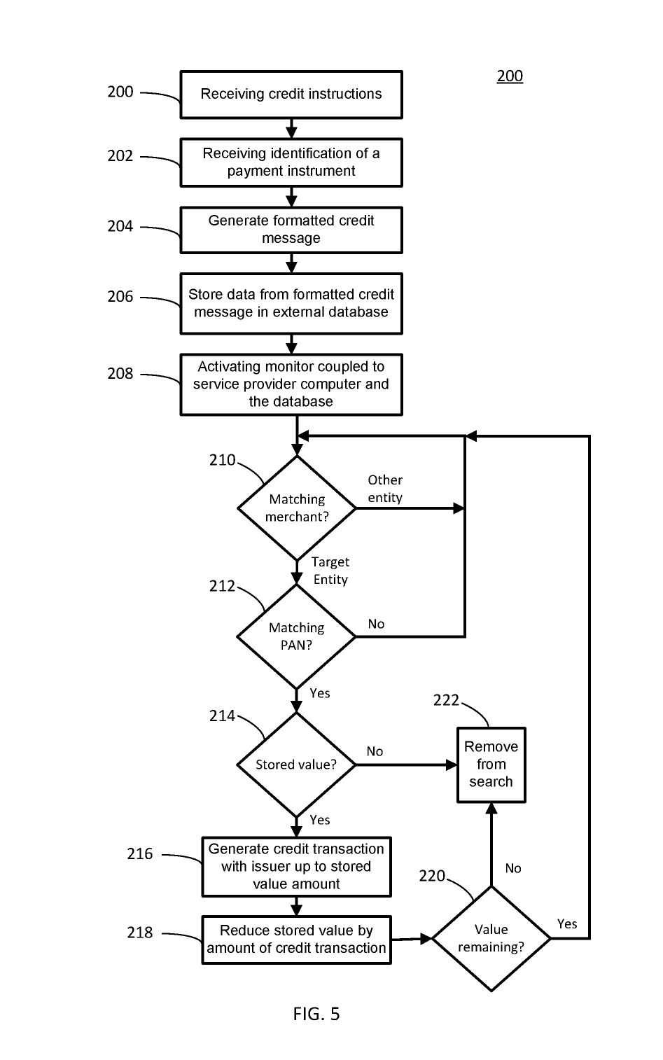

FIG. 5 is a flow chart of an exemplary method of managing application of gift or other credit value for a user. At block 200, a credit instruction may be received via, for example, a customer service terminal 124. In one embodiment, the customer service terminal 124 may be in a retail environment but in another embodiment, the customer service terminal 124 may be in a telephone center or other customer service support environment. In yet another embodiment the credit instruction may be received via an online transaction. The credit instruction may include an amount of credit to be applied and any rules for use such as a merchant or merchant brand at which the store credit may redeemed. In an embodiment, at block 202, the customer's open loop card identifier may be physically read using a card device 152 or may simply be entered via a user interface of the customer service terminal 124. The card number may be a customer card's PAN or may be a token entered, for example, via a token device such as Apple Pay.

After the credit instructions and open loop card identifier are captured, a credit message may be formatted at block 204 and sent to a downstream partner such as service provider 114. At block 206, the downstream partner may identify the message and store the credit message information, for example, in a database 133. Once a store credit has been entered, at block 208 a monitor 130 may be activated to screen transactions processed by the service provider 114 in order to identify those transactions that qualify for application of store credit.

At block 210, transactions being processed by the service provider 114 may be reviewed and analyzed for content, in this case, for merchants for whom store credit has been instantiated. That is, any transaction involving a merchant that is holding store credit may cause the process to continue to block 212, while a merchant that does not hold store credit may cause the process to loop back to review another transaction. At block 212, a check may be made to determine that the PAN associated with the transaction matches a PAN for which stored credit is available. If so processing may continue at block 214, if not, processing may return to block 210. Any additional filters for application of the store credit such as, but not limited to, specific merchant brand, items purchased (e.g., not all items may be eligible for application of the credit), time of day or day of week. As may be apparent, the order of steps 210 and 212 may be changed or the screening process may be implemented in block so that only one test is made.

A determination of stored value may be made at block 214. At this point a check for positive value may be made including commitments on current funds not yet settled. When value exists, processing may continue at block 216. In some embodiments, the remaining value may also be communicated. When no value exists, at block 222, the account may be removed from the search space so that the PAN is no longer screened for that merchant. In addition, in some embodiments, a notification of no balance may be communicated.

At block 216, the monitor 130 may generate a credit for the PAN up to the value of either the transaction or the store credit remaining for that PAN. If an amount of store credit exceeds the value of the transaction, the store credit value may be reduced by the amount credited in the transaction. If value remains at block 220, processing continues at block 210. If no store credit remains, execution continues at block 222 and the PAN is removed from the search space as discussed above.

A technical effect may be the addition of the monitor 130 to the prior art payment processing system, including the parser 172, rules engine 174 and notification generator 178. These capabilities may expand the functionality of the prior art system with features and functions supporting the application and use of credit linked to an open loop card. Another technical effect may be the physical and programmatic changes to a prior art systems resulting in the customer service terminal 124. Yet another technical effect may be the APIs and protocols used to communicate the credit offer details and use which may result in a more efficient computing system. Finally, the back end user interface may provide a technical solution of how to easily create and monitor an electronic, open loop credit campaign.

The use of the system 120 benefits both merchants and customers. Merchants may be able to improve the customer experience of store credits and gift value purchases while receiving other tangible benefits such as retention of funds until an actual refundable transaction is settled. Further, the merchant no longer needs to pay a separate pre-paid card issuer 116 for accepting and managing the store or gift credit value. This may not only improve cash flow but may also reduce escheatment issues associated with unused funds. Fraudulent refunds may be reduced when perpetrators are faced with enrolling value with either their own card, allowing them to be tracked, or another person's card such that the value may become inaccessible.

Customers may benefit by eliminating the need to remember to carry and use separate stored value and gift cards. The customer may also have reduced concerns associated with lost or stolen stored value cards because the value is associated with his or her credit card account, not the card itself so that even the loss of the open loop card may not result in loss of stored value.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

We claim:

1. A method of using a monitoring infrastructure for collecting and disbursing directed funds associated with a merchant, the method comprising:
receiving, at a merchant server, a funding message corresponding to receipt of a first value by the merchant and a personal account number (PAN) of an open loop card to be associated with the funds;
receiving, at a monitor, a personal account number (PAN) of an open loop card to be associated with the funds;
receiving, at the monitor, a plurality of records for open loop card transactions conducted with the merchant;
determining, at the monitor, when a first record of the plurality of records contains the PAN associated with the first value;
calculating a credit amount that is less than or equal to the first value to be applied to a transaction associated with the first record;
sending, via the monitor, a message that causes the credit amount to be applied to the transaction;
generating, at the monitor, a settlement message transferring the credit amount directly from the merchant to the clearing service.

2. The method of claim 1, further comprising creating a record of the first value and PAN at the monitor responsive to receiving the funding message at the merchant server.

3. The method of claim 1, wherein creating a record of the funds and PAN at the monitor responsive to receiving the funding message at the merchant server

4. The method of claim 1, wherein receiving, at the monitor, the plurality of records comprises receiving every open loop card transaction conducted with the merchant.

5. The method of claim 1, wherein receiving the funding message at a merchant server comprises generating the funding message at a merchant terminal corresponding to receipt of cash at the merchant terminal.

6. The method of claim 1, wherein sending the message that causes the credit amount to be applied to the transaction comprises sending the message to the clearing service for application of the credit amount as a statement credit.

7. The method of claim 1, wherein sending the message that causes the credit amount to be applied to the transaction comprises sending the message to the clearing service for application of the credit amount in real time at a point of sale device of the merchant to reduce an amount of the transaction.

8. The method of claim 1, further comprising reducing the first value by the credit amount responsive to sending the message that causes the credit amount to be applied to the transaction.

9. The method of claim 1, further comprising enrolling the PAN with the merchant prior to receiving the funding message.

10. The method of claim 1, further comprising sending a message to a person associated with the PAN responsive to receiving the funding message.

11. The method of claim 1, further comprising sending a second message with the credit amount to a person associated with the PAN responsive to sending the message that causes the credit amount to be applied to the transaction.

12. The method of claim 11, wherein sending the second message to the person associated further comprises sending a remaining balance associated with the PAN in the second message.

13. A monitor that performs restricted credits to a user, the monitor comprising:
a central processing unit (CPU);
a memory coupled to the CPU;
an input coupled to the CPU and further coupled to a service provider that processes transactions;
a parser coupled to the input, the parser programmed to:
i) receive a first data set from a service provider corresponding to receipt of a first value by a merchant and a personal account number (PAN) of an open loop card of a user to be associated with the first value;
ii) receive a second data set corresponding to a transaction from the service provider, the transaction between the merchant and the user, the parser further programed to separate the data set into individual component elements;
a database interface that uses selected individual component elements from the first data set to generate a query string for a database, the query string identifying a stored value record that matches predetermined criteria corresponding to the component elements;
a rules engine coupled to the database interface that receives the matching stored value record and applies a rule set to determine that conditions are met corresponding to application of at least a portion of a predetermined credit amount and to further determine a value of the credit amount;
a message generator coupled to the rules engine, the message generator programmed to generate a message that causes the value of the credit amount to be moved from the merchant to the open loop card.

14. The monitor of claim 13, wherein the merchant funds the credit amount to be moved from the merchant to the open loop card from a merchant account holding the first value.

15. The monitor of claim 13, wherein the message generator sends the message to an issuer of the open loop card.

16. The monitor of claim 13, wherein the message generator generates the message in real time to reduce an amount of the transaction by the value of the credit amount.

17. The monitor of claim 13, wherein the monitor further receives a registration message that enrolls the PAN of the open loop card with the merchant prior to receipt of the first data set.

18. The monitor of claim 13, further comprising a notification generator that generates a signal received by the user indicating the transaction will be credited the value of the credit amount.

19. A method of performing transaction-related cashless credits to a user by an entity, the method comprising:
receiving, at a merchant server, a funding message corresponding to receipt of a first value by the merchant and a personal account number (PAN) of an open loop card to be associated with the first value;
creating a record of the first value and PAN at the monitor responsive to receiving the funding message at the merchant server;
receiving, at a monitor, a plurality of records for every open loop card transaction conducted with the merchant;
determining, at the monitor, when a first record of the plurality of records contains the PAN associated with the funds;
calculating a credit amount that is less than or equal to the first value to be applied to a transaction associated with the first record;
sending, via the monitor, a message that causes the credit amount to be applied to the transaction;
reducing the first value by the credit amount responsive to sending the message that causes the credit amount to be applied to the transaction;
generating, at the monitor, a settlement message transferring the credit amount directly from the merchant to the clearing service.

20. The method of claim 19, further comprising creating a record of the funds and PAN at the monitor responsive to receiving the funding message at the merchant server.
